(19) United States
(12) Patent Application Publication
(10) Pub. No.: US 2026/0142304 A1
(43) Pub. Date: May 21, 2026

(54) DEBONDABLE ADHESIVE ASSEMBLY FOR BATTERY PACK

(71) Applicant: Ford Global Technologies, LLC, Dearborn, MI (US)

(72) Inventor: Zubair Khan, Villa Park, IL (US)

(21) Appl. No.: 19/335,384

(22) Filed: Sep. 22, 2025

Related U.S. Application Data
(60) Provisional application No. 63/721,756, filed on Nov. 18, 2024.
(60) Provisional application No. 63/721,761, filed on Nov. 18, 2024.
(60) Provisional application No. 63/721,767, filed on Nov. 18, 2024.
(60) Provisional application No. 63/721,771, filed on Nov. 18, 2024.
(60) Provisional application No. 63/721,779, filed on Nov. 18, 2024.

(51) Int. Cl. H01M 50/264; C09J 7/20; H01M 10/613; H01M 10/625; H01M 10/6554; H01M 10/6556; H01M 50/244; H01M 50/249

(52) U.S. Cl. CPC H01M 50/264; C09J 7/201; H01M 10/613; H01M 10/625; H01M 10/6554; H01M 50/244; H01M 50/249; C09J 2203/33; C09J 2301/416; C09J 2301/502; C09J 2483/005; H01M 10/6556

(57) ABSTRACT

A debondable adhesive assembly for use in a battery pack includes a UV-curable release layer configured to be disposed between a first battery pack component and a second battery pack component, and an adhesive configured to bond the battery pack component to the second component. The UV-curable release layer is activatable by ultraviolet radiation to reduce an adhesion strength of the adhesive and to facilitate debonding of the battery pack component from the second component.

### CROSS-REFERENCE TO RELATED APPLICATIONS

This application claims the benefit of U.S. Provisional Application Nos. 63/721,756; 63/721,761; 63/721,767; 63/721,771; and 63/721,779, each filed on Nov. 18, 2024, the disclosures of which are hereby incorporated by reference in their entireties.

### TECHNICAL FIELD

This disclosure relates generally to bonding traction battery pack components and, more particularly, to debondable adhesive assemblies.

### BACKGROUND

Adhesives are used in traction battery packs to bond together various components. From time to time, debonding the adhesives may be desired. Debonding the adhesive could be necessary so that the components can be separated during a service or repair of the battery pack.

### SUMMARY

In some aspects, the techniques described herein relate to a debondable adhesive assembly for use in a battery pack, including: a UV-curable release layer configured to be disposed between a first battery pack component and a second battery pack component; and an adhesive configured to bond the battery pack component to the second component, wherein the UV-curable release layer is activatable by ultraviolet radiation to reduce an adhesion strength of the adhesive and facilitate debonding of the battery pack component from the second component.

In some aspects, the techniques described herein relate to a debondable adhesive assembly, wherein the first battery pack component is a cell stack; and the second battery pack component is a thermal exchange plate of a traction battery pack.

In some aspects, the techniques described herein relate to a debondable adhesive assembly, wherein the first battery pack component is a battery cell.

In some aspects, the techniques described herein relate to a debondable adhesive assembly, wherein the UV-curable release layer includes 5 to 30 percent by weight silicone diacrylate, 10 to 20 percent by weight cycloaliphatic epoxide, and 6 to 10 percent by weight phosphate salt.

In some aspects, the techniques described herein relate to a debondable adhesive assembly, wherein the adhesive includes one or more oligomers selected from a group consisting of silicone diacrylate, epoxy acrylate, urethane acrylate, and polyester acrylate.

In some aspects, the techniques described herein relate to a debondable adhesive assembly, wherein the UV-curable release layer further includes an organic peroxide present in an amount of 5 to 6 percent by weight.

In some aspects, the techniques described herein relate to a debondable adhesive assembly, wherein the UV-curable release layer includes a cationic photoinitiator selected from iodonium salts and phosphonium salts.

In some aspects, the techniques described herein relate to a debondable adhesive assembly, wherein the UV-curable release layer has a peripheral area extending beyond an interface between the first and second battery pack components by a distance in a range of 1 to 20 millimeters.

In some aspects, the techniques described herein relate to a debondable adhesive assembly, wherein the debondable adhesive assembly includes a plurality of discrete sections, each section bonding one or more individual battery cells of the first battery pack component to the second battery pack component.

In some aspects, the techniques described herein relate to a debondable adhesive assembly, further including a thermal interface material disposed between the adhesive and the first battery pack component.

In some aspects, the techniques described herein relate to a method of debonding a first battery pack component from a second battery pack component, including: exposing a first portion of a UV-curable release layer to ultraviolet radiation, the UV-curable release layer having a second portion extending between the first battery pack component and the second battery pack component; activating the UV-curable release layer to reduce an adhesion strength of an adhesive bonding the first battery pack component to the second battery pack component; and separating the first battery pack component from the second battery pack component.

In some aspects, the techniques described herein relate to a method, wherein exposing the UV-curable release layer to ultraviolet radiation includes directing ultraviolet radiation onto a peripheral area of the UV-curable release layer that extends beyond an interface between the first battery pack component and the second battery pack component.

In some aspects, the techniques described herein relate to a method, wherein activating the UV-curable release layer initiates polymerization of cationic components within the UV-curable release layer.

In some aspects, the techniques described herein relate to a method, wherein the UV-curable release layer includes 5 to 30 percent by weight silicone diacrylate, 10 to 20 percent by weight cycloaliphatic epoxide, and 6 to 10 percent by weight phosphate salt.

In some aspects, the techniques described herein relate to a method, wherein the adhesive includes one or more oligomers selected from a group consisting of silicone diacrylate, epoxy acrylate, urethane acrylate, and polyester acrylate.

In some aspects, the techniques described herein relate to a method, wherein the UV-curable release layer and the adhesive are parts of a debondable adhesive assembly, and further including dividing the debondable adhesive assembly into a plurality of discrete sections, each section bonding one or more individual battery cells of the first battery pack component to the second battery pack component.

In some aspects, the techniques described herein relate to a method, further including disposing a thermal interface material between the adhesive and the first battery pack component.

In some aspects, the techniques described herein relate to a method, wherein the UV-curable release layer includes a cationic photoinitiator selected from iodonium salts and phosphonium salts.

In some aspects, the techniques described herein relate to a method, wherein the UV-curable release layer further includes an organic peroxide present in an amount of 5 to 6 percent by weight.

In some aspects, the techniques described herein relate to a method, wherein the UV-curable release layer has a peripheral area extending beyond an interface between the first battery pack component and the second battery pack component by a distance in a range of 1 to 20 millimeters.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, partially expanded view of the battery pack of FIG. 1.

FIG. 3 illustrates a section view through a cell stack taken at line 3-3 in FIG. 2

FIG. 4 illustrates a close-up view of an area of FIG. 3.

FIG. 5 illustrates a close-up view of an area of FIG. 4.

FIG. 6 illustrates a top view of one of the cell stacks of FIG. 2 within an enclosure tray.

### DETAILED DESCRIPTION

This disclosure is directed toward debondable adhesives and assemblies that incorporate such adhesives. In some embodiments, the debondable adhesives bond together components, but can be selectively weakened or released when exposed to a specific stimulus, such as ultraviolet (UV) light, heat, or chemical agents. In the context of battery packs, debondable adhesives are used to bond components such as battery cells, cell holders, modules, thermal barriers, and enclosure assemblies during manufacturing and assembly.

Using debondable adhesives in battery packs can facilitate easier servicing, repair, or replacement of individual components. Traditional adhesives form comparatively permanent bonds that can be difficult to rupture.

In some examples, a debondable adhesive assembly includes a UV-curable release layer that can be activated when exposed to UV light. Activating the release layer causing the adhesive to lose bonding strength and allowing the bonded components to be separated without requiring excessive force.

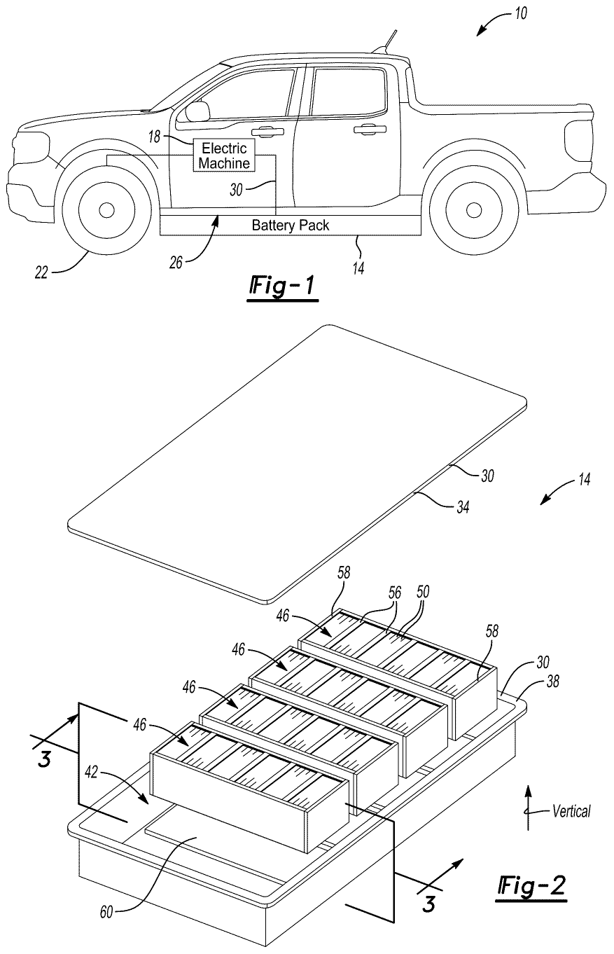

With reference to FIG. 1, an electrified vehicle 10 includes a traction battery pack 14, an electric machine 18, and wheels 22. The battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

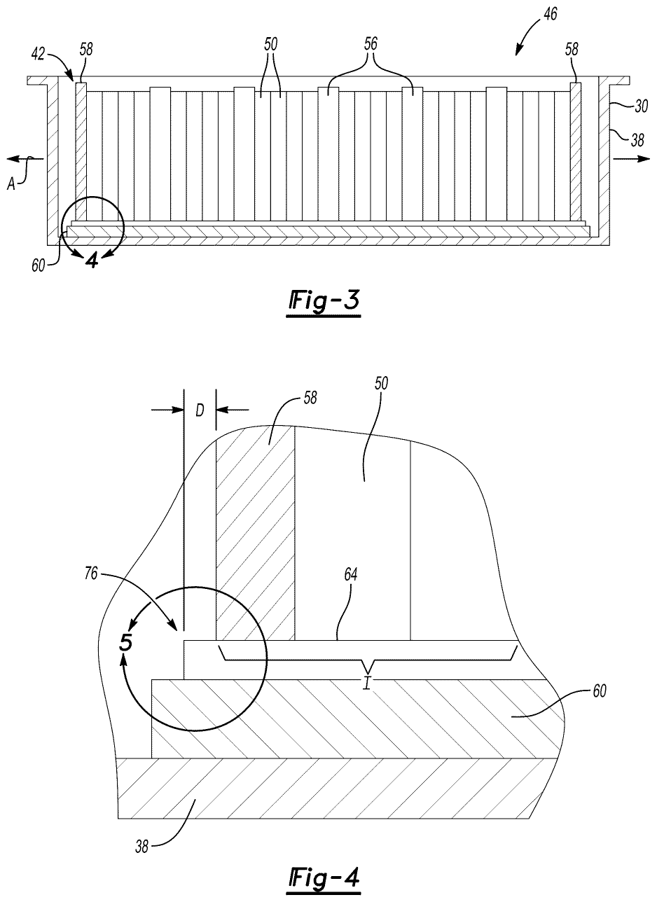

With reference now to FIGS. 2 and 3, the example battery pack 14 includes an enclosure assembly 30 having a cover 34 and a tray 38. The cover 34 is secured to the tray 38 to establish an interior area 42. In this example, the cover 34 can be welded to the tray 38. The cover 34 could be secured to the tray 38 using other types of connections in other examples, such as with adhesive or with mechanical fasteners. While an exemplary enclosure assembly 30 is shown in the drawings, the enclosure assembly 30 may vary in shape, size, and configuration within the scope of this disclosure.

The battery pack 14 includes various components housed within the interior area 42. The components, in this example, include a plurality of cell stacks 46 each including a plurality of individual battery cells 50 and a plurality of thermal barrier assemblies 56 disposed along a respective cell stack axis A. The cell stacks 46 are sandwiched along the respective cell stack axis A between a pair of endplates 58.

The thermal barrier assemblies 56 are sandwiched between groups of the battery cells 50 along the cell stack axis A. The groups of battery cells 50 can include, for example, four individual battery cells 50. The groups of battery cells 50 could include other numbers of individual battery cells 50 in other examples. In some examples, the group of individual battery cells 50 includes a single one of the battery cells 50.

The example battery pack 14 includes four cell stacks 46 within the interior area 42. The battery pack 14 could employ other number of cell stacks 46 in other examples. Thus, the teachings of this disclosure should not be considered to the exact configuration shown in FIGS. 2 and 3. Further, while the cell stacks 46 of the exemplary embodiment are positioned side-by-side relative to one another within the interior area 42, other configurations are contemplated within the scope of this disclosure. Including, but not limited to, embodiments where the cell stacks 46 are stacked on top of one another.

In the exemplary embodiment, the battery cells 50 are pouch-style, lithium-ion cells. However, battery cells having other geometries (cylindrical, prismatic, etc.), other chemistries (nickel-metal hydride, lead-acid, etc.), or both could be alternatively utilized within the scope of this disclosure.

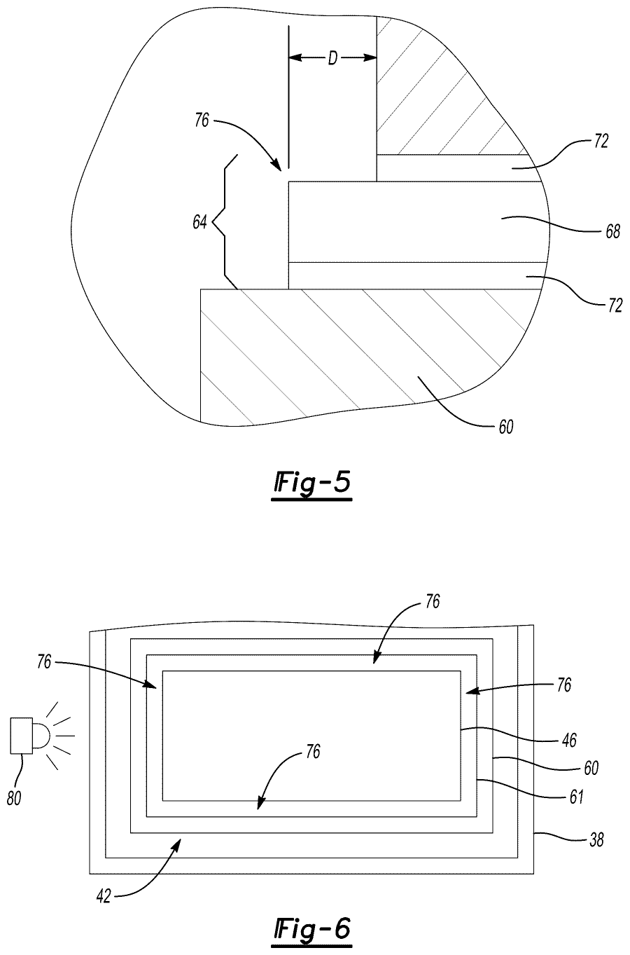

With reference now to FIGS. 4-6, and continuing reference to FIGS. 2 and 3, the example cell stacks 46 are each disposed on a thermal exchange plate 60. Coolant can be circulated through the thermal exchange plates 60 to manage thermal energy levels in the battery cells 50 and other components.

In this example, a debondable adhesive assembly 64 is used to secure each of the cell stacks 46, a type of battery component, to one of the thermal exchange plates 60, another type of battery component. The example debondable adhesive assembly 64 includes a UV-release layer 68 and an adhesive 72 disposed on both sides of UV-release layer 68. In some examples, a thermal interface material could be positioned between the debondable adhesive assembly 64 and the cell stack 46 or between the debondable adhesive assembly 64 and the thermal exchange plate 60.

The UV-release layer 68 is UV-curable. For purposed of this disclosure, “UV-release layer” refers to a layer that undergoes a chemical change when exposed to ultraviolet (UV) radiation, which enables or facilitates the debonding of an adhesive. This process is known as UV-curing, where the layer is activated by UV light to reduce adhesion strength and allow separation of bonded components.

The UV-release layer 68 is activatable by UV radiation to reduce the adhesion strength of the adhesive 72 and facilitate debonding of the cell stack 46 from the thermal exchange plate 60. To activate the UV-release layer 68, the UV-release layer 68 can be exposed to UV radiation emitted from a UV light 80 (see FIG. 6).

The debondable adhesive assembly 64 can be a film with a thin layer of pressure sensitive adhesive applied to both sides. The debondable adhesive assembly 64 can be used as a base layer before structural adhesives, gap filling adhesives and other sealants applied.

The debondable adhesive assembly 64, in this example, includes a peripheral area 76 that projects a distance D beyond an interface I between the cell stacks 46 and the thermal exchange plate 60. In this example, the distance D is few millimeters, say in a range of 1 to 20 millimeters. In a specific example, the distance D is 10 millimeters. The peripheral area 76 is exposed and is not disposed between the cell stack 46 and the thermal exchange plate 60.

In this example, the UV light 80 directs UV radiation onto the peripheral area 76 to activate the UV-release layer 68. The UV light 80 may direct the UV radiation onto the peripheral area 76 for say one or two minutes.

After activation, the UV light 80 can then be removed, but the activation of the UV-release layer 68 initiated by the UV radiation continues to propagate through the UV-release layer 68 along the interface I. After some time, the activation of the UV-release layer 68 has sufficiently disrupted the bond between the cell stack 46 and the thermal exchange plate 60 so that the cell stack 46, or individual battery cells 50, can be removed and replaced or serviced. In some examples, it may take several days for the activation to disrupt the bond so that the cell stack 46 or individual battery cells 50 can be removed.

In some examples, the debondable adhesive assembly 64 could be divided up to include several sections each bonding one or more battery cells 50 to the thermal exchange plate 60. In such examples, one or more sections could be activated to facilitate removing one or more battery cells 50 rather than the entire cell stack 46.

Activation of the UV-release layer 68 initiates polymerization. In some examples, the chemistry of the UV-release layer 68 can include cationic components such as iodonium and phosphonium salts to initiate cationic polymerization that does not need exposure of UV for the areas of the UV-release layer 68 that are within the interface I and are covered. In some examples, 0.5 seconds to 1 seconds of UV exposure is enough to breakdown the cationic photoinitiator to initiate polymerization. The use of cationic chemistry in photoinitiation facilitates complete polymerization of the cationic components. Extending the UV coating few millimeters beyond the interface I provides an exposed region that can allow the UV to initiate the cationic polymerization of the covered areas along the interface I.

The adhesive 72 can include, in some examples, oligomers of silicone diacrylate that release and debond upon UV exposure. The adhesive 72 could instead or additionally include oligomers of epoxy acrylate, urethane acrylate, polyester acrylate or some combination of these. The adhesive 72 could additionally include cycloaliphatic epoxide that provides mechanical properties.

The UV-release layer 68, in some examples, can be from 5 to 30 percent by weight silicone diacrylate, 10 to 20 percent by weight cycloaliphatic epoxide, and 6 to 10 percent by weight phosphate salt. These cationic photoinitiators are, in some examples, available as a 50 percent salt solution in a solvent, such as propylene carbonate. The silicone diacrylate can provides the release or debonding upon UV exposure in the peripheral area 76. The cycloaliphatic epoxide and phosphate salt can provide curing in the covered areas of the interface I where the UV radiation cannot reach

The UV-release layer 68 can additionally include 5 to 6 percent by weight organic peroxide to provide the free radical upon exposure to thermal energy that does not depend solely on exposure to UV radiation.

In some examples, the adhesive can incorporate type I photoinitiators, type II photoinitiators, or both, along with an amine synergist, such as a tertiary amine, to increase free radical polymerization.

While described in connection with the cell stacks 46 and thermal exchange plate 60, the battery pack component bonded by the debondable adhesive assembly may be any suitable element within the battery pack, and is not limited to a battery cell or a thermal exchange plate. For example, the battery pack component could include cell holders, module frames, thermal barriers, enclosure covers, trays, busbars, control modules, or other structural or functional components commonly found in battery packs. The debondable adhesive assembly could bond the enclosure tray to the enclosure cover, for example. The debondable adhesive assembly is adaptable for use with a wide variety of battery pack components, thereby facilitating serviceability, repair, or replacement of diverse elements within the battery pack architecture.

A debondable adhesive assembly according to another exemplary embodiment can be an adhesive composition that incorporate nanoparticles of relatively high thermal conductivity to facilitate thermal energy transfer. The particles can include nanodiamond particles (monocrystalline or polycrystalline of the size of 30 to 250 nanometers), copper particles or both. These thermal conductive particles could be incorporated into adhesives being used within a battery pack whether the adhesive is a structural adhesive, a gap filling adhesive, or a pressure sensitive adhesive. The thermal conductive particles could also be incorporated within the plastic enclosure components, such as trays, during molding and could be applied as a topcoat after the molding. The diamond and copper particle coating could also be applied throughout the external surface of the battery cells, over the adhesives, over the plastic tray, over the cooling plates.

Known structural adhesives contain fillers such as silicon dioxide, calcium silicate, wollastonite, Alumina, which are not as thermally conductive as, for example, nanodiamond particles. By incorporating diamond and/or copper nanoparticles within the adhesive composition or applying a diamond coating over the surrounding surfaces over the battery cell, over the plastic tray, over the metal parts, within the dielectric layers thermal transfer within the battery pack can be increased.

In another exemplary embodiment, debonding of adhesives in a battery pack is facilitated by placing mechanical barriers in between the cells. The mechanical barriers can be metal or non-metal barriers. An example metal barrier could be any metal with thermal conductivity to dissipate heat. An example non-metal barrier is a shrink sleeve film based on Polyester, Polycarbonate, or Polyvinylidene fluoride (PVDF). PVDF is a dielectric and could be helpful in minimizing dielectric loss within the pack.

In a specific example, a thermally debondable hotmelt adhesive film is glazed on both sides of a shrink film. The resulting structure is then wrapped around each battery cell. The hotmelt and shrink film surface faces a battery cell on a first side and a structural adhesive on an opposite, second side. Melting the hotmelt adhesive film can debond the battery cells.

In another exemplary embodiment, an inert resin is incorporated into an adhesive that bonds components of a battery pack. The inert resin can facilitate thermal debonding of the adhesive. The inert resin can be a resin that debonds by heat and that bonds by cooling. The inert resin can be a resin that does not crosslink but provides barrier properties. The example insert resin does not interfere in lowering functional property requirements of the adhesive.

Current structural adhesive(s) being supplied by the adhesive manufacturers are typically based on chemistries that crosslink to form a network that is hard to debond, especially with relatively high filler content. Incorporating an inert resin with the structural adhesive without sacrificing the crosslinking ability of the adhesive and also without sacrificing the barrier properties of the adhesive remains in the system can facilitate the debonding by heat or by radiation exposure such as UV.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A debondable adhesive assembly for use in a battery pack, comprising:
a UV-curable release layer configured to be disposed between a first battery pack component and a second battery pack component; and
an adhesive configured to bond the battery pack component to the second component, wherein the UV-curable release layer is activatable by ultraviolet radiation to reduce an adhesion strength of the adhesive and facilitate debonding of the battery pack component from the second component.

2. The debondable adhesive assembly according to claim 1, wherein the first battery pack component is a cell stack; and the second battery pack component is a thermal exchange plate of a traction battery pack.

3. The debondable adhesive assembly of claim 1, wherein the first battery pack component is a battery cell.

4. The debondable adhesive assembly according to claim 1, wherein the UV-curable release layer comprises 5 to 30 percent by weight silicone diacrylate, 10 to 20 percent by weight cycloaliphatic epoxide, and 6 to 10 percent by weight phosphate salt.

5. The debondable adhesive assembly according to claim 1, wherein the adhesive comprises one or more oligomers selected from a group consisting of silicone diacrylate, epoxy acrylate, urethane acrylate, and polyester acrylate.

6. The debondable adhesive assembly according to claim 1, wherein the UV-curable release layer further comprises an organic peroxide present in an amount of 5 to 6 percent by weight.

7. The debondable adhesive assembly according to claim 1, wherein the UV-curable release layer comprises a cationic photoinitiator selected from iodonium salts and phosphonium salts.

8. The debondable adhesive assembly according to claim 1, wherein the UV-curable release layer has a peripheral area extending beyond an interface between the first and second battery pack components by a distance in a range of 1 to 20 millimeters.

9. The debondable adhesive assembly according to claim 1, wherein the debondable adhesive assembly comprises a plurality of discrete sections, each section bonding one or more individual battery cells of the first battery pack component to the second battery pack component.

10. The debondable adhesive assembly according to claim 1, further comprising a thermal interface material disposed between the adhesive and the first battery pack component.

11. A method of debonding a first battery pack component from a second battery pack component, comprising:
exposing a first portion of a UV-curable release layer to ultraviolet radiation, the UV-curable release layer having a second portion extending between the first battery pack component and the second battery pack component;
activating the UV-curable release layer to reduce an adhesion strength of an adhesive bonding the first battery pack component to the second battery pack component; and
separating the first battery pack component from the second battery pack component.

12. The method of claim 11, wherein exposing the UV-curable release layer to ultraviolet radiation comprises directing ultraviolet radiation onto a peripheral area of the UV-curable release layer that extends beyond an interface between the first battery pack component and the second battery pack component.

13. The method of claim 11, wherein activating the UV-curable release layer initiates polymerization of cationic components within the UV-curable release layer.

14. The method of claim 11, wherein the UV-curable release layer comprises 5 to 30 percent by weight silicone diacrylate, 10 to 20 percent by weight cycloaliphatic epoxide, and 6 to 10 percent by weight phosphate salt.

15. The method of claim 11, wherein the adhesive comprises one or more oligomers selected from a group consisting of silicone diacrylate, epoxy acrylate, urethane acrylate, and polyester acrylate.

16. The method of claim 11, wherein the UV-curable release layer and the adhesive are parts of a debondable adhesive assembly, and further comprising dividing the debondable adhesive assembly into a plurality of discrete sections, each section bonding one or more individual battery cells of the first battery pack component to the second battery pack component.

17. The method of claim 11, further comprising disposing a thermal interface material between the adhesive and the first battery pack component.

18. The method of claim 11, wherein the UV-curable release layer comprises a cationic photoinitiator selected from iodonium salts and phosphonium salts.

19. The method of claim 11, wherein the UV-curable release layer further comprises an organic peroxide present in an amount of 5 to 6 percent by weight.

20. The method of claim 11, wherein the UV-curable release layer has a peripheral area extending beyond an interface between the first battery pack component and the second battery pack component by a distance in a range of 1 to 20 millimeters.
